(19) United States
(12) Patent Application Publication
(10) Pub. No.: US 2009/0181613 A1
(43) Pub. Date: Jul. 16, 2009

(54) Wireless control system and method thereof

(76) Inventors: Jyi-Yuan Chen, Tsao Tuen (TW); Chun-Huang Lee, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,607

(22) Filed: Jan. 14, 2008

(51) Int. Cl. H04H 40/63

(52) U.S. Cl. 455/3.06

(57) ABSTRACT

A wireless control system includes a first wireless electronic apparatus and a second wireless electronic apparatus. The first wireless electronic apparatus executes a search function to obtain a second apparatus identification message of the second wireless electronic apparatus, and confirms whether the second wireless electronic apparatus is connectable according to the second apparatus identification message. When the second wireless electronic apparatus is connectable, the first wireless electronic apparatus wirelessly connects to the second wireless electronic apparatus, and receives an input event from a second input interface of the second wireless apparatus. Then, the first wireless electronic apparatus executes the input event according to a first operating table, which defines the correspondence relationship between a first input interface of the first wireless electronic apparatus and the second input interface.

### BACKGROUND OF THE INVENTION

1. Field of the Invention

The present invention is related to a control system and method thereof, and more particularly to a wireless control system and method thereof which can achieve a wireless mutual control between electronic apparatuses.

2. Description of Related Art

Electronic apparatuses with various functions are developed for satisfying all kinds of operation demands. Furthermore, wireless communication technology has also become more and more popular because the electronic apparatus can no longer be limited by wire-bound connection in the light of the available wireless communication technology.

According to different operation demands, one may own multiple electronic apparatuses with different functions, and if the user wants to operate several of the electronic apparatuses at the same time, it might come to pass that the user cannot control the electronic apparatus which is away from him or her.

For example, if a car driver tries to control the electronic apparatus (such as, vehicle audio system, vehicle computer or navigation device) during driving, then the operation might distract the driver from driving and increase the risk of car accident. Therefore, if other passengers can substitute the driver to control the electronic device, then it will be better for driving safety.

However, it still might happen that the passenger can not smoothly operate the electronic apparatus which is located at the console owing to him or her being blocked by the seat, for example, when the passenger sits in the backseat, he or she might encounter difficulties to control and operate the front-seat electronic apparatus.

### SUMMARY OF THE INVENTION

Therefore, the object of the present invention is to provide a wireless control system and method which utilizes wireless communication technology to achieve a mutual control between wireless electronic apparatuses, so as to remotely control one electronic apparatus through a input interface of the other electronic apparatus.

For solving the problem described above, the present invention provides a wireless control method applied to a wireless control between a first wireless electronic apparatus and a second wireless electronic apparatus. The method includes the steps of: the first wireless electronic apparatus executing a search function to obtain a second apparatus identification message from the second wireless electronic apparatus; the first wireless electronic apparatus judging if the second wireless electronic apparatus is connectable in accordance with the second apparatus identification message; the first wireless electronic apparatus connecting to the second wireless electronic apparatus when the second wireless electronic apparatus is connectable; the second wireless electronic apparatus receiving an input event from a second input interface thereof and wirelessly outputting an input operating signal to the first wireless electronic apparatus; and the first wireless electronic apparatus executing the input operating signal according to a first operating table, wherein the first operating table defines a correspondence relationship between a first input interface of the first wireless electronic apparatus and the second input interface.

Furthermore, the present invention also provides a wireless control system including a first wireless electronic apparatus having a first input interface and a first operating table, and a second wireless electronic apparatus, having a second input interface and a second apparatus identification message, wherein the first wireless electronic apparatus judges if the second wireless electronic apparatus is connectable depending on searching and obtaining the second apparatus identification message from the second wireless electronic apparatus; the first wireless electronic apparatus connects to the second wireless electronic apparatus when the second wireless electronic apparatus is connectable, receives an input operating signal which is outputted by the second wireless electronic apparatus in accordance with an input event, and executes the input operating signal according to the first operating table; and the first operating table defines a correspondence relationship between the first input interface and the second input interface.

Through the descriptions above, the user can remotely control the first wireless electronic apparatus through an input event from the second wireless electronic apparatus, and the second input interface is compatible with the first input interface of the first wireless electronic apparatus.

### BRIEF DESCRIPTION OF THE DRAWINGS

The foregoing aspects and many of the attendant advantages of this application will be more readily appreciated as the same become better understood by reference to the following detailed description, when taken in conjunction with the accompanying drawings, wherein:

FIG. 1 is a block diagram showing a wireless control system in a preferred embodiment according to the present invention;

FIG. 2 is a flow chart showing a wireless control method in a preferred embodiment according to the present invention; and

FIG. 3 is a flow chart showing the message communications between the first wireless electronic apparatus and the second wireless electronic apparatus in a preferred embodiment according to the present invention.

### DETAILED DESCRIPTION OF PREFERRED EMBODIMENTS

The present invention is related to a mutual control between two wireless electronic apparatuses which provides the function that one electronic apparatus can control the other one through the input interface thereof, so that the user can control a remote wireless electronic apparatus through a local wireless electronic apparatus.

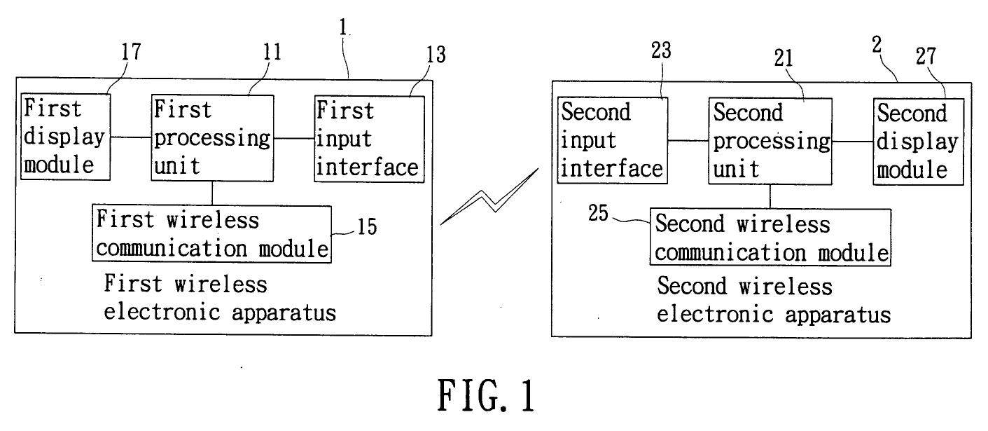

Please refer FIG. 1 which is a block diagram showing a wireless control system according to the present invention. In this embodiment, the wireless control system includes a first wireless electronic apparatus 1 and a second wireless electronic apparatus 2, wherein the first wireless electronic apparatus 1 and the second wireless electronic apparatus 2 can respectively control the other one through executing a remote control function thereof. The execution of the remote control function is that the user can remotely control and operate the first wireless electronic apparatus 1 through a second input interface 23 of the second wireless electronic apparatus 2, and oppositely, the user also can remotely control and operation the second wireless electronic apparatus 2 through a first input interface 13 of the first wireless electronic apparatus 1.

The first wireless electronic apparatus 1 and the second wireless electronic apparatus 2 achieve mutual remote control by establishing a communication protocol between them, so that they can have a common language for communication, and thus, the processing procedures (such as, identification, connection establishment and remote input control) used for executing the remote control can be achieved.

Following, the architectures and functions of the first wireless electronic apparatus 1 and the second wireless electronic apparatus 2 are described. The first wireless electronic apparatus 1 includes a first processing unit 11, a first input interface 13, a first wireless communication module 15, and a first display module 17, wherein the first processing unit 11 is coupled to the first input interface 13, the first wireless communication module 15 and the first display module 17 respectively. The second wireless electronic apparatus 2 includes a second processing unit 21, a second input interface 23, a second wireless communication module 25, and a second display module 27, wherein the second processing unit 21 is coupled to the second input interface 23, the second wireless communication module 25 and the second display module 27 respectively. The first wireless electronic apparatus 1 and the second wireless electronic apparatus 2 can be identical or different kinds of electronic apparatuses, for example, can be portable devices, such as cell phone, PDA (Personal Digital Assistant), and PND (Portable navigation Device), or can be telematics, such as vehicle audio system, mobile TV, navigation device, and trip computer.

The first processing unit 11 and the second processing unit 21 respectively receive the input control from the user through the first input interface 13 and the second input interface 23, and respectively send out wireless signal through the first wireless communication module 15 and the second wireless communication module 25. The first processing unit 11 and the second processing unit 21 provide the major control mechanism for function execution and operation respectively in the first wireless electronic apparatus 1 and the second wireless electronic apparatus 2. The control mechanism is achieved by cooperation between microprocessor (not shown) and hardware needed for the related function module, such as storage module, navigation module or audio module. Here, these are only listed for illustration, and different kinds of electronic apparatuses can have different modules according to different demands. Besides, the microprocessor provides the functions through executing a control procedure, which is usually implemented by codes.

The control procedure executed by the first processing unit 11 includes the function of remote control. When executing remote control, through cooperating with the pre-stored identification data and data related to operation in the first processing unit 11, it can judge that whether the connection with and the remote control to the second wireless electronic apparatus 2 can be achieved. Here, this identification data can be a first apparatus identification message for providing the standards of the first wireless electronic apparatus 1. In this embodiment, the first apparatus identification data message can provide the hardware standards of the first input interface 13, such as the type, amount and function of the input element of the first input interface 13, so that the second wireless electronic apparatus 2 can confirm that if the first input interface 13 of the first wireless electronic apparatus 1 is compatible with the second input interface 23.

Moreover, in the first processing unit 11, a table recording the correspondence relationship between devices capable of being connected and the input interface is further provided. For example, a first connection list can record the devices can be selected to connect and a first operating table can record the correspondence relationship between the second input interface 23 and the first input interface 13. Take the first operating table as an example. In this table, there are various kinds of combinations of correspondence relationships between the second input interface 23 of the second wireless electronic apparatus 2 and the first input interface 13 of the first wireless electronic apparatus 1, such that the first wireless electronic apparatus 1 can receive and identify the control and operation message inputted from the second input interface 23 of the second wireless electronic apparatus 2 through the first operating table, thereby converting the control and operation message into the control and operation signals corresponding to the first input interface 13. For example, when the first input interface 13 and the second input interface 23 both belong to keyboard module, the first operating table may at least record the correspondence relationship between the keys in the keyboard module of the first input interface 13 and the keys :in the keyboard module of the second input interface 23 one by one, and also record the functions executed by the keys.

Identically, the second processing unit 21 has a similar remote control execution to the first processing unit 11. The second processing unit 21 provides a second apparatus identification message, a second connecting list and a second operating table, wherein the second: apparatus identification message provides the hardware standards of the second input interface 23, such as the type, amount and function of the input element of the second input interface 23, so that the first wireless electronic apparatus 1 can confirm that if the second input interface 23 of the second wireless electronic apparatus 2 is compatible with the first input interface 13. In the second operating table, there are various kinds of combinations of correspondence relationships between the first input interface 13 of the first wireless electronic apparatus 1 and the second input interface 23 of the second wireless electronic apparatus 2, such that the second wireless electronic apparatus 2 can receive and identify the control and operation message inputted from the first input interface 13 of the first wireless electronic apparatus 1 through the second operating table, thereby converting the control and operation message into the control and operation corresponding to the second input interface 23.

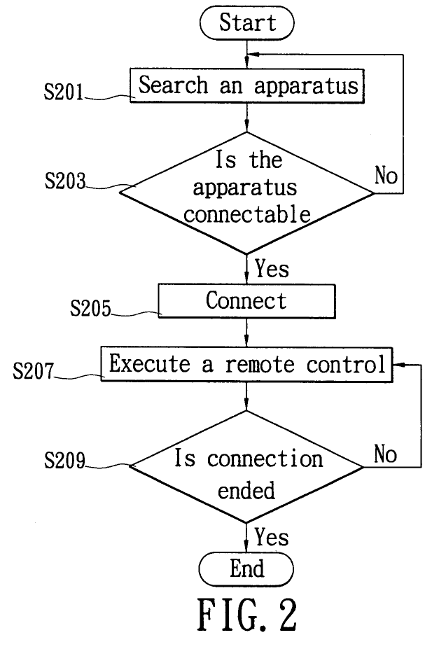

Please refer FIG. 2 which is a flow chart showing a wireless control method in a preferred embodiment according to the present invention, and please also refer FIG. 1 for further understand. The steps of the wireless control method in this embodiment are related to the first wireless electronic apparatus 1 requesting the second wireless electronic apparatus 2 to process the connection as both initiate the remote control function.

First, the first wireless electronic apparatus 1, through the first wireless communication module 15, executes a search function to find the device which identically supports the remote control function (S201). When the second wireless electronic apparatus 2 is found, the first wireless electronic apparatus 1 will judge that if the second wireless electronic apparatus 2 can be connected according to the second apparatus identification message (S203), and if negative, the flow goes back to step S201 for finding another connectable device.

If positive in step S203, the first wireless electronic apparatus 1 processes the connection to the second wireless electronic apparatus 2 (S205), and the second wireless electronic apparatus 2 may process the remote control to the first wireless electronic apparatus 1 through the second input interface 23 (S207). Then, it will decide that whether the connection between the first wireless electronic apparatus 1 and the second wireless electronic apparatus 2 is ended (S209). If positive, then the remote control function is ended, or the flow goes back to step S207.

Although FIG. 2 illustrates the example that the first wireless electronic apparatus 1 requests to connect to the second wireless electronic apparatus 2 and the second input interface 23 of the second wireless electronic apparatus 2 is used to process the remote control to the first wireless electronic apparatus 1, in practice, the present invention also can be implemented as the second wireless electronic apparatus 2 requests to connect to the first wireless electronic apparatus 1 and the first input interface 13 of the first wireless electronic apparatus 1 is used to process the remote control to the second wireless electronic apparatus 2.

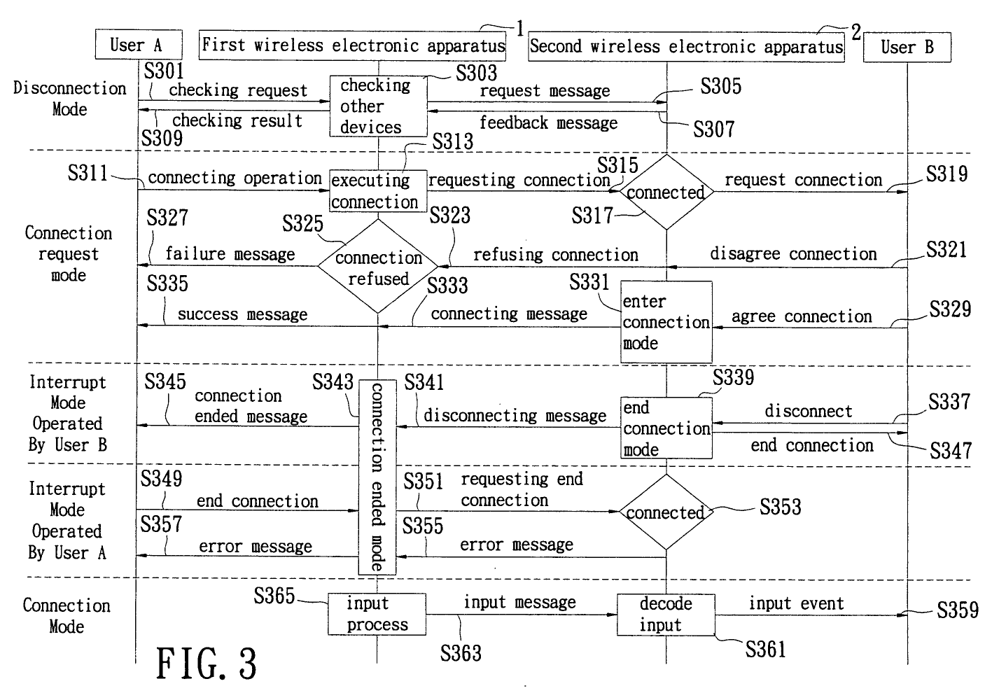

For more clearly clarifying the details of FIG. 2, please refer to FIG. 3, which is a flow chart showing the message communications between the first wireless electronic apparatus 1 and the second wireless electronic apparatus 2 in a preferred embodiment according to the present invention. In FIG. 3, the user A requests to connect with the second wireless electronic apparatus 2 through the first wireless electronic apparatus 1, and the user B processes the remote control to the first wireless electronic apparatus 1 through the second wireless electronic apparatus 2. Besides, FIG. 3 can be divided into non-connection mode, connection requesting mode, disconnection mode by user A, disconnection mode by user B and connection mode. The detailed steps are described as followed.

First of all, it should be mentioned that the message transmission between the first wireless electronic apparatus 1 and the second wireless electronic apparatus 2 are achieved through the first wireless communication module 15 and the second wireless communication module 25.

In the non-connection mode, the first wireless electronic apparatus 1 receives the checking request inputted by user A through the first input interface 13 (S301), so as to check if there any other electronic apparatus with remote control function is found and output requesting signal if positive (S305). After the second wireless electronic apparatus 2 receives the requesting signal, since the second wireless electronic apparatus 2 provides the remote control function, the second wireless electronic apparatus 2 outputs a feedback signal to the first wireless electronic apparatus 1 (S307), wherein the feedback signal may contains the second apparatus identification message. The first wireless electronic apparatus 1 judges that if the second wireless electronic apparatus 2 is a connectable device with remote control function in accordance with the received second apparatus identification message. The judging result is shown through the first display module 11 of the first wireless electronic apparatus 1, so as to notify user A (S309).

The purpose of the first wireless electronic apparatus 1 to judge the second apparatus identification message is to confirm that if the hardware standards of the second input interface 23 are able to compatible with the first input interface 13. Since the second apparatus identification message records the standards of the second input interface 23, it can find that if the first operating table defines the correspondence relationship between the second input interface 23 of the second wireless electronic apparatus 2 and the first input interface 13. If positive, then the second wireless electronic apparatus 2 can be connected to the first wireless electronic apparatus 1 for usage, and oppositely, if negative, then the second wireless electronic apparatus 2 can not be connected to the first wireless electronic apparatus 1 for usage.

In the connection mode, when the second wireless electronic apparatus 2 is identified to be able to connect with the first wireless electronic apparatus 1, the second wireless electronic apparatus 2 is added to the first connecting list in the first wireless electronic apparatus 1. At this time, the first wireless electronic apparatus 1 can receive the selection related to the second wireless electronic apparatus 2 from user A through the first input interface 13 for requesting the connecting operation (S311), and then, the first wireless electronic apparatus 1 executes the connecting operation (S313) and outputs a connection requesting signal to the second wireless electronic apparatus 2 (S315). After the second wireless electronic apparatus 2 receives this connection requesting signal, firstly, it will judge that if there any other device has connected thereto (S317). If negative, the second display module 27 will show the connection request for notifying user B (S319), and then, user B can input the agreement to the connecting operation through the second input interface 23 (S329). At this time, the second wireless electronic apparatus 2 enters the connection mode (S331), and outputs a connection receiving signal to the first wireless electronic apparatus 1 (S333). Then, the first display module 17 of the first wireless electronic apparatus 1 displays a connection success message to notice user A (S335).

Therefore, after the connection between the first wireless electronic apparatus 1 and the second wireless electronic apparatus 2 is completed, the first display module 17 of the first wireless electronic apparatus 1 will show the message that it is operated by the second wireless electronic apparatus 2, and the second display module 27 of the second wireless electronic apparatus 2 will show the message that it is capable of operating the first wireless electronic apparatus 1.

In the connection requesting mode, after the second wireless electronic apparatus 2 receives the connection requesting signal, user B can disagree the connection request by inputting the disagreement through the second input interface 23, no matter the second wireless electronic apparatus 2 is already connected with other device or not (S321), so as to output a connection refusing signal to the first wireless electronic apparatus 1 (S323). The first wireless electronic apparatus 1 will judge that if the connection is refused (S325), and after receiving the connection refusing signal outputted from the second wireless electronic apparatus 2, the first display module 17 of the first wireless electronic apparatus 1 will display a connection failure message to notice user A (S327).

In the disconnection mode by user B, the second input interface 23 of the second wireless electronic apparatus 2 receives a disconnection request from user B (S337), so that the second wireless electronic apparatus 2 ends the connection mode (S339) and outputs a disconnection signal to the first wireless electronic apparatus 1 (S341), and then, the second display module 27 of the second wireless electronic apparatus 2 displays a connection ended message for notifying user B (S347). After the first wireless electronic apparatus 1 receives the disconnection signal, it ends the connection mode (S343) and the first display module 17 of the first wireless electronic apparatus 1 display the connection ended message for notifying user A (S345).

In the disconnection mode by user A, the first input interface 13 of the first wireless electronic apparatus 1 receives a connection ending request from user A (S349) for ending the connection mode (S343), and then, the first wireless electronic apparatus 1 outputs a connection ending request to the second wireless electronic apparatus 2 (S351). After the second wireless electronic apparatus 2 receives the request, it will judge that if the connection mode is under processing. If yes, the second wireless electronic apparatus 2 will end the connection mode (S339) and output a disconnection signal to the first wireless electronic apparatus 1 (S341), and if not, then the second wireless electronic apparatus 2 outputs an error signal to the first wireless electronic apparatus 1, such that the first display module 17 of the first wireless electronic apparatus 1 displays an error message for notifying user A (S357).

In connection mode, after the second input interface 23 of the second wireless electronic apparatus 2 receives an input event from user B (S359), it will decode the input (S361) and output an input operating signal to the first wireless electronic apparatus 1 (S363). Then, according to the input operating signal, the first wireless electronic apparatus 1 finds out the correspondence relationship between the second input interface 23 and the first input interface 13, so as to covert the input operating signal into the corresponding operation of the first input interface 13, so that, according to the corresponding relation ship, the first wireless electronic apparatus 1 can process the input event from the second wireless electronic apparatus 2.

For example, in practice, the first wireless electronic apparatus 1 can be a cell phone and the second wireless electronic apparatus 2 can be a vehicle audio system, so that the passenger seated at the back seat can control the vehicle audio system in front of the car through the cell phone held thereby, and oppositely, the driver seated at the front seat also can control the cell phone of the passenger at the back seat through the vehicle audio system in front of the car.

Here, the first input interface 13 and the second input interface 23 can be various kinds of input interfaces, such as remote input module, keyboard module or touch control module.

In the aforesaid, according to the present invention, the first wireless electronic apparatus 1 and the second wireless electronic apparatus 2 can have a remote mutual control therebetween through the first input interface 13 and the second input interface 23 respectively thereof, so that the user can control a remote wireless electronic apparatus: through a local wireless electronic apparatus in a wireless manner. Besides, the input interfaces of both wireless electronic apparatuses are compatible with each other.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A wireless control method, applied to a wireless control between a first wireless electronic apparatus and a second wireless electronic apparatus, the method comprising the steps of:
executing a search function by the first wireless electronic apparatus to obtain a second apparatus identification message from the second wireless electronic apparatus;
judging if the second wireless electronic apparatus is connectable by the first wireless electronic apparatus in accordance with the second apparatus identification message;
connecting to the second wireless electronic apparatus by the first wireless electronic apparatus when the second wireless electronic apparatus is connectable;
receiving an input event by the second wireless electronic apparatus from a second input interface thereof and wirelessly outputting an input operating signal to the first wireless electronic apparatus; and
executing the input operating signal by the first wireless electronic apparatus according to a first operating table, wherein the first operating table defines a correspondence relationship between a first input interface of the first wireless electronic apparatus and the second input interface.

2. The method as claimed in claim 1, wherein the second apparatus identification message provides hardware standards of the second input interface.

3. The method as claimed in claim 1, wherein the first wireless electronic apparatus will confirm that the second wireless electronic apparatus is connectable if the first operating table contains the correspondence relationship of the first and the second input interfaces according to the second apparatus identification message.

4. The method as claimed in claim 1, further comprising steps of:
displaying a confirmation by the first wireless electronic apparatus if the second wireless electronic apparatus is connectable.

5. The method as claimed in claim 1, further comprising step of: adding the second wireless electronic apparatus into a first connecting list of the first wireless electronic apparatus when the second wireless electronic apparatus is connectable.

6. The method as claimed in claim 5, wherein the first wireless electronic apparatus and the second wireless electronic apparatus are connected through selecting the second wireless electronic apparatus in the first connecting list.

7. The method as claimed in claim 1, further comprising step of:
the first wireless electronic apparatus displays a message representing that it is operated by the second wireless electronic apparatus when the first wireless electronic apparatus and the second wireless electronic apparatus are connected.

8. The method as claimed in claim 1, further comprising step of:
the second wireless electronic apparatus displays a message representing that it is able to operate the first wireless electronic apparatus when the first wireless electronic apparatus and the second wireless electronic apparatus are connected.

9. The method as claimed in claim 1, prior to the first wireless electronic apparatus executing the search function, further comprising the following step:
the first wireless electronic apparatus and the second wireless electronic apparatus respectively initiating a remote control function.

10. The method as claimed in claim 1, wherein the first input interface and the second input interface is a keyboard module, a touch control module or a remote control module.

11. The method as claimed in claim 1, wherein the second wireless electronic apparatus receives the input event through the second input interface.

12. The method as claimed in claim 1, wherein the first wireless electronic apparatus looks up the correspondence relationship between the second input interface and the first input interface from the first operating table according to the input operating signal, and executes the input event inputted by the second wireless electronic apparatus according to the found correspondence relationship.

13. A wireless control method, comprising steps of:
(a) providing a first wireless electronic apparatus and a second wireless electronic apparatus, wherein the first wireless electronic apparatus comprises a first apparatus identification message and a first operating table, and the second wireless electronic apparatus comprises a second apparatus identification message and a second operating table;
(b) when processing a search function, the first wireless electronic apparatus executing the steps of:
(b1) obtaining the second apparatus identification message by the first wireless electronic apparatus from the second wireless electronic apparatus;
(b2) judging if the second wireless electronic apparatus is connectable by the first wireless electronic apparatus in accordance with the second apparatus identification message;
(b3) connecting to the second wireless electronic apparatus by the first wireless electronic apparatus when the second wireless electronic apparatus is connectable;
(b4) receiving an input event by the second wireless electronic apparatus from a second input interface thereof and wirelessly outputting an input operating signal to the first wireless electronic apparatus; and
(b5) executing the input operating signal by the first wireless electronic apparatus according to the first operating table, wherein the first operating table defines a correspondence relationship between a first input interface of the first wireless electronic apparatus and the second input interface; and
(c) when processing a search function, the second wireless electronic apparatus executing steps of:
(c1) obtaining the first apparatus identification message by the second wireless electronic apparatus from the first wireless electronic apparatus;
(c2) judging if the first wireless electronic apparatus is connectable by the second wireless electronic apparatus in accordance with the first apparatus identification message;
(c3) connecting to the first wireless electronic apparatus by the second wireless electronic apparatus when the first wireless electronic apparatus is connectable;
(c4) receiving an input event by the first wireless electronic apparatus from the first input interface thereof and wirelessly outputting an input operating signal to the second wireless electronic apparatus; and
(c5) executing the input operating signal by the second wireless electronic apparatus according to the second operating table, wherein the second operating table defines a correspondence relationship between the second input interface of the second wireless electronic apparatus and the first input interface.

14. The method as claimed in claim 13, wherein the first apparatus identification message provides hardware standards of the first input interface, and the second apparatus identification message provides hardware standards of the second input interface.

15. The method as claimed in claim 13, wherein, in step (b2), the first wireless electronic apparatus will confirm that the second wireless electronic apparatus is connectable if the first operating table contains the correspondence relationship of the first and the second input interfaces according to the second apparatus identification message.

16. The method as claimed in claim 13, wherein, in step (c2), the second wireless electronic apparatus will confirm that the first wireless electronic apparatus is connectable if the second operating table contains the correspondence relationship of the first and the second input interfaces according to the first apparatus identification message.

17. The method as claimed in claim 13, wherein, in step (b3), when the second wireless electronic apparatus is connectable, a step further comprises: judging if the second wireless electronic apparatus is connected with another wireless electronic apparatus, and connecting the first wireless electronic apparatus to the second wireless electronic apparatus only if the second wireless electronic apparatus is not connected to another wireless electronic apparatus.

18. The method as claimed in claim 13, wherein, when the first wireless electronic apparatus is connectable, step (c3) further comprises the step of: judging if the first wireless electronic apparatus is connected with another wireless electronic apparatus, and connecting the second wireless electronic apparatus to the first wireless electronic apparatus only if the first wireless electronic apparatus is not connected to another wireless electronic apparatus.

19. The method as claimed in claim 13, wherein in step (b5), the first wireless electronic apparatus looks up the correspondence relationship between the second input interface and the first input interface from the first operating table according to the input operating signal, and executes the input event inputted by the second wireless electronic apparatus according to the found correspondence relationship.

20. The method as claimed in claim 13, wherein, in step (c5), the second wireless electronic apparatus looks up the correspondence relationship between the first input interface and the second input interface from the second operating table according to the input operating signal, and executes the input event inputted by the first wireless electronic apparatus according to the found correspondence relationship.

21. A wireless control system, comprising:
a first wireless electronic apparatus, having a first input interface and a first operating table; and
a second wireless electronic apparatus, having a second input interface and issuing a second apparatus identification message, for receiving an input event through the second input interface and correspondingly outputting an input operating signal, wherein
the first wireless electronic apparatus is used to search the second wireless electronic apparatus so as to obtain the second apparatus identification message, and to judge if the second wireless electronic apparatus is connectable in accordance with the second apparatus identification message;
the first wireless electronic apparatus connects to the second wireless electronic apparatus when the second wireless electronic apparatus is connectable, receives the input operating signal, and executes the input operating signal according to the first operating table; and
the first operating table defines a correspondence relationship between the first input interface and the second input interface.

22. The wireless control system as claimed in claim 21, wherein the first input interface and the second input interface are keyboard modules, touch control modules or remote control modules.

23. The wireless control system as claimed in claim 21, wherein the second apparatus identification message provides hardware standards of the second input interface.

24. The wireless control system as claimed in claim 21, wherein the first wireless electronic apparatus confirms that the second wireless electronic apparatus is connectable, if the first operating table contains the correspondence relationship of the first and the second input interfaces according to the second apparatus identification message.

25. The wireless control system as claimed in claim 21, wherein the first wireless electronic apparatus looks up the correspondence relationship between the second input interface and the first input interface from the first operating table according to the input operating signal, and executes the input event inputted by the second wireless electronic apparatus according to the found correspondence relationship.
